(19) United States
(12) Patent Application Publication
(10) Pub. No.: US 2015/0280366 A1
(43) Pub. Date: Oct. 1, 2015

(54) METHOD OF ATTACHING POWER CABLE AND HOME APPLIANCE WITH POWER CABLE

(71) Applicants: BSH Bosch und Siemens Hausgeräte GmbH, Munich (DE); BSH Home Appliances Corporation, Irvine, CA (US)

(72) Inventors: Robert Jones, New Bern, NC (US); Ansar Tanvir, New Bern, NC (US)

(73) Assignees: BSH Bosch und Siemens Hausgeräte GmbH, Munich (DE); BSH Home Appliances Corporation, Irvine, CA (US)

(21) Appl. No.: 14/225,479

(22) Filed: Mar. 26, 2014

(51) Int. Cl. H01R 13/639; H01R 43/00

(52) U.S. Cl. CPC H01R 13/6392; H01R 43/00

(57) ABSTRACT

A method of assembling a power cable to a home appliance includes determining a side that the cable will be routed out of, determining an orientation of a positioning device corresponding to the determined side; fastening the positioning device adjacent to a locating mark to fix the orientation, the locating mark being the same regardless of the orientation; electrically connecting the cable to a power cable receptacle on the home appliance; fastening the cable to the positioning device; and routing the cable out of the determined side. A home appliance includes a housing; a power cable electrically connected to a power receptacle offset towards one side of the home appliance; and a positioning device adapted to position and hold the cable. The power cable extends from the housing a same length whether the cable is routed out of the left side or the right side.

### FIELD OF THE TECHNOLOGY

The present technology relates to a method of assembling a home appliance and to the home appliance. More particularly, the present technology relates to a method of connecting a power cable to a home appliance and to the resultant home appliance.

### BACKGROUND

Domestic appliances have electrical power cables that are governed by standards promulgated by the Underwriters Laboratory (UL) and/or the National Electrical Code (NEC). One aspect governed by the standards is that the power cable cannot extend beyond a body or housing of a given type of domestic appliance more than a certain length. For example, a power cable should not extend more than 1.2 meters beyond the point where the power cable exits a dishwasher housing. 1.2 meters is about twice the width of a standard installation bay for a dishwasher.

### BRIEF SUMMARY

If the power cable exits from a fixed location on a domestic appliance, certain disadvantages may occur. For example, if the power cable exits the domestic appliance at a left-most edge of the appliance, then the power cable can reach a power outlet that is located nearly the entire length of the power cable away from the appliance on that side. However, if the power outlet is located opposite the left-most edge (i.e., on a right side of the appliance), then the power outlet cannot be located as far away because the power cable starts on the “wrong” side of the appliance. Of course, the opposite is true with a power cable that exits the domestic appliance at a right-most edge of the appliance.

If the power cable is located centrally on the domestic appliance, a power outlet at either side is equally limited in that the power cable must be routed half way across the appliance and that distanced is effectively wasted length of the power cable.

Such fixed locations for power cables result in disadvantages in that there are installation configurations where the power cable is not located optimally.

An aspect of the present technology solves one or more problems of the prior art.

Another aspect of the present technology includes a method of attaching a power cable to a domestic appliance and the resultant domestic appliance.

Another aspect of the present technology includes a power cable that can be routed out of opposite sides of an appliance while maintaining the maximum allowed length regardless of the chosen side.

Another aspect of the present technology includes a method of assembling a power cable to a home appliance, the method comprising: determining a side that the power cable will be routed out of the home appliance, the determined side being a right side or a left side; determining an orientation of a positioning device corresponding to the determined side; fastening the positioning device to fix the orientation, the positioning device being fastened adjacent to a locating mark on the home appliance that is disposed between the left side and the right side of the home appliance, the locating mark being the same regardless of the orientation; electrically connecting the power cable to a power cable receptacle on the home appliance; fastening the power cable to the positioning device; and routing the power cable out of the determined side.

In examples, (a) the orientation is a first orientation or a second orientation, the first orientation and the second orientation being rotated 90° apart from one another, (b) the locating mark is a leg adjuster for the home appliance, (c) the positioning device is located such that the power cable extends a same distance outside of a housing of the home appliance regardless of the determined side without altering the overall length of the power cable, (d) the home appliance includes a back strap at the determined side, (e) the power cable is routed through the back strap, (f) the home appliance is a dishwasher, (g) the positioning device is a clip with an opening, the opening is oriented up when the determined side is the right side and the opening is oriented towards the right side when the determined side is the left side, (h) the power cable receptacle is located on the left side, (i) the positioning device is a clip with an opening, the opening is oriented up when the determined side is opposite the power cable receptacle and the opening is oriented away from the power cable receptacle when the determined side is a side where the power cable receptacle is located, and/or (j) the method is performed in the order recited.

Another aspect of the present technology includes a home appliance comprising: a housing with a left side and a right side; a power cable electrically connected to a power receptacle that is set off towards one side of the home appliance; and a positioning device adapted to position and hold the power cable, wherein the power cable extends from the housing a same length when the power cable is routed out of the left side and when the cable is routed out of the right side.

In examples, (a) the positioning device is adapted to be oriented in a first orientation or and a second orientation, the first orientation and the second orientation being rotated 90° apart from one another, (b) the home appliance includes no more than one power receptacle adapted to mate with the power cable, (c) the positioning device is adapted to be oriented in a first orientation or and a second orientation, the first orientation and the second orientation being rotated 90° apart from one another, (d) the home appliance includes no more than one power receptacle adapted to mate with the power cable and the power cable is mated with the power receptacle, (e) the power receptacle is located on a rear portion of the home appliance and facing towards the back of the home appliance, the power cable being routed out of the home appliance at approximately a same height as the power receptacle, (f) the home appliance includes a locating mark to locate the positioning device, (g) the locating mark is a leg adjuster, (h) the home appliance includes a back strap at the left side or the right side, wherein the power cable is routed through the back strap, (i) the home appliance is a dishwasher, (j) the positioning device is a clip that is substantially D-shaped and that allows the power cable to pass into and out of the D-shape at an opening at a top of the D-shape, and/or (k) the power cable has a predetermined overall length that is longer than the length the power cable extends from the home appliance.

Another aspect of the present technology includes a home appliance comprising: a power receptacle; a power cable; a positioning device adapted to be oriented in a first position and a second position depending which of two sides of the home appliance that the power cable is routed out of; and a locating mark on the home appliance that is disposed between the two sides of the home appliance, the locating mark being the same regardless of the orientation; wherein the power cable is electrically connected to the power receptacle, fastened to the home appliance by the positioning device, and routed out of one of the two sides.

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

FIG. 1 is a partial rear view of a domestic appliance;

FIG. 2A is a detailed partial view of a lower, rear portion of the domestic appliance with a power cable routed out of a right side of the domestic appliance;

FIG. 2B is an enlarged portion of FIG. 2A;

FIG. 3A is a detailed partial view of a lower, rear portion of the domestic appliance with a power cable routed out of a left side of the domestic appliance; and

FIG. 3B is an enlarged portion of FIG. 3A.

### DETAILED DESCRIPTION

The following description is provided in relation to several examples which may share common characteristics and features. It is to be understood that one or more features of any one example may be combinable with one or more features of the other examples. In addition, any single feature or combination of features in any of the examples may constitute additional examples.

Throughout this disclosure, terms such as first, second, third, etc. may be used. However, these terms are not intended to be limiting or indicative of a specific order, but instead are used to distinguish similarly described features from one another, unless expressly noted otherwise. Terms such as substantially and about are intended to allow for variances to account for manufacturing tolerances, measurement tolerances, or variations from ideal values that would be accepted by those skilled in the art.

Throughout this disclosure, the terms left side and right side are used. These terms are only intended to provide relational orientation with respect to one another. Any two opposed sides can be a right side and a left side and by changing to an opposed viewpoint, right versus left will be changed. Thus, right side and left side should not be considered limiting and are used only to distinguish their relationship to one another.

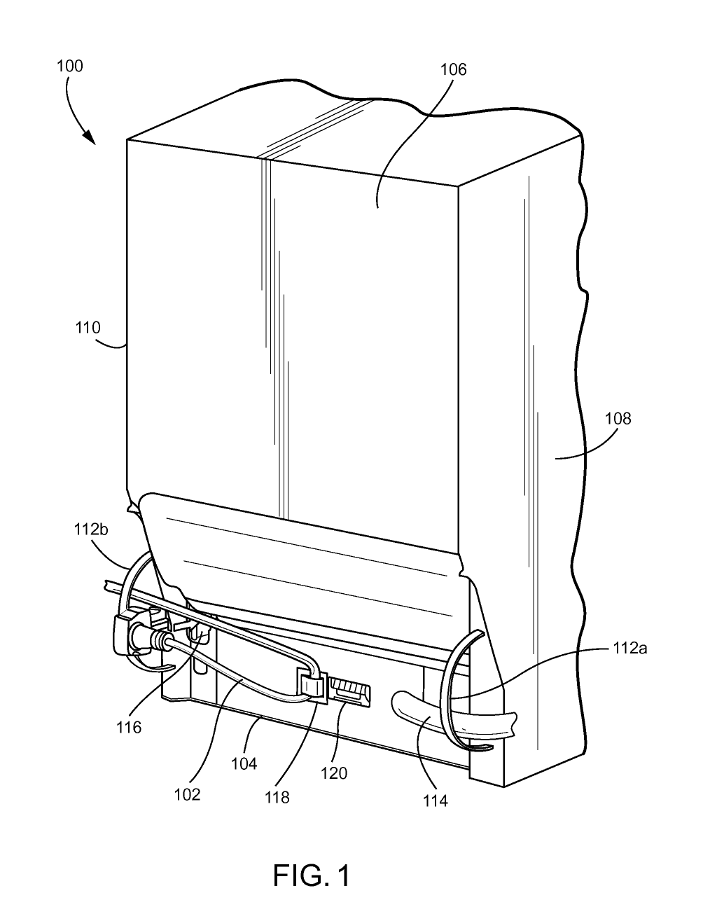

FIG. 1 illustrates a rear view of a domestic appliance 100, illustrated as a dishwasher, with a power cable 102 positioned, e.g., generally along a bottom edge 104 of the rear side 106 of the domestic appliance 100. The domestic appliance includes opposing lateral sides that are referred to as a right side 108 and a left side 110. Near at least one of the right side 108 and the left side 110 is at least one back strap 112a, 112b. The back straps 112a, 112b provide structure to route items, such as the power cable 102 and a drain hose 114, that can be in different positions relative to the domestic appliance 100 depending on the particulars of a given installation. The power cable 102 is illustrated as being routed through the left back strap 112b and a drain hose 114 is illustrated as being routed through the right back strap 112a but the power cable 102 and the drain hose 114 can be routed through either back strap 112a, 112b, or through the same one.

The power cable 102 is illustrated as detached from a power cable receptacle 116 so that the power cable receptacle 116 is visible. The power cable receptacle 116 is located adjacent to the left back strap 112b but could be located at any convenient location. As illustrated, the domestic appliance includes no more than one power receptacle 116 adapted to mate with the power cable 102. The power receptacle 116 may be located vertically such that it is between uppermost and lowermost bounds of the back straps 112a, 112b.

The power cable 102 is attached to a positioning device 118, which is described in greater detail below, adjacent to a locating mark 120. The locating mark 120 is illustrated in the form of a leg adjuster that allows a leg to be adjusted for leveling the domestic appliance 100. The locating mark 120 can be in the form of any convenient structure and could be (a) any type of mark added to the domestic appliance (for example, marks made from ink or paint, an adhesive label, etc.), (b) a structure on the domestic appliance only for the purpose of signifying the location (for example, a hole, an indentation, a protrusion, etc.), (c) some functional structure (such as the illustrated leg adjuster, an electrical or liquid connection, etc.) and/or (d) an unmarked but predetermined location (for example, coordinates measured from an identifiable location and determined by a measuring device or specialized tool). Any object that is identifiable and appropriately located can serve as the locating mark 120. In an example, the locating mark 120 is located such that the positioning device 118 will be located substantially midway between the back straps 112a, 112b.

The domestic appliance 100 is illustrated without any structure to cover the power cable receptacle 116, back straps 112a, 112b, locating mark 120 or positioning device 118. However, a cover could be provided if desired.

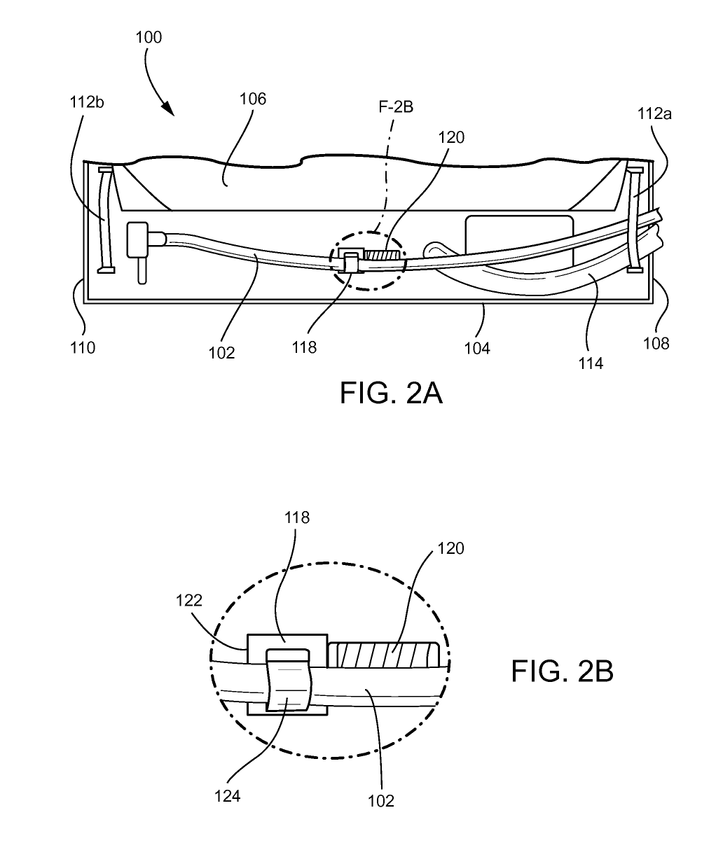

FIG. 2A is a detailed view of a lower portion of the rear side 106 of the domestic appliance 100. The power cable 102 is routed from the power cable receptacle 116 (near the left side 110), through the positioning device 118 and through the back strap 112a adjacent to the right side 108. The portion of the power cable 102, or drain hose 114, extending beyond the back straps 112a, 112b may be considered as outside of or exiting the domestic appliance 100 or a housing of the domestic appliance 100.

FIG. 2B is a detailed view of FIG. 2A that illustrates the positioning device 118 and locating mark 120. The positioning device is illustrated as clip with a base 122 (illustrated as substantially square or rectangular) and a cable retaining portion 124. Together the base 122 and retaining portion 124 form a substantially U-shaped portion or a substantially D-shaped portion (where the top of the D is not connected) adapted to retain the power cable 102 that passes there through. Other configurations of the positioning device 118 may be employed as well. Indeed, any type of device that allows for the power cable 102 to be fixed and oriented as described herein may be used as the positioning device 118.

The retaining portion 124 is connected to the base 122 towards the bottom edge 104 and retaining portion 124 is not connected away from the bottom edge 104. Such a configuration allows the power cable 102 to pass into or out of the retaining portion while the power cable 102 tends to stay within the positioning device 118 by way of frictional retention. As illustrated, gravity will also tend to retain the power cable 102 within the retaining portion 102. However, the positioning device 118 could also be oriented inverted (e.g., rotated 180°) with respect to the illustrated orientation.

In order to assemble the home appliance 100 as illustrated in FIGS. 2A and 2B, a user determines that the power cable 102 will be routed out the right side 108. The positioning device 118 is oriented in the illustrated orientation, e.g., with the opening up, which allows the power cable 102 to pass through the positioning device from left to right or right to left, and the positioning device 118 is fixed adjacent to the locating mark 120. The power cable 102 is inserted into the power cable receptacle 116, inserted into the positioning device 118, and routed through the back strap 112a. The steps can be performed in any order, or the order recited.

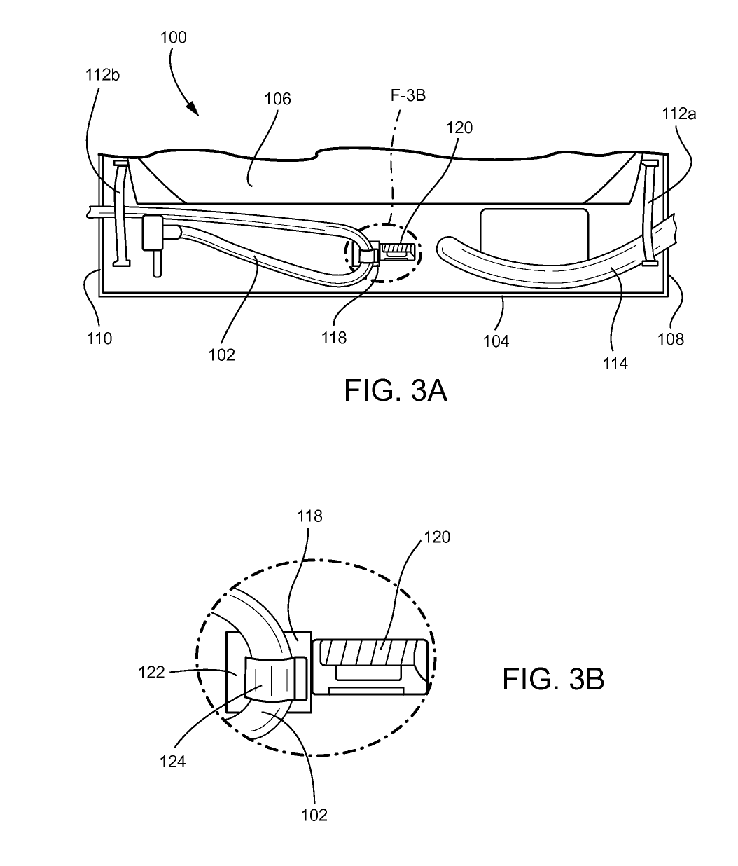

FIGS. 3A and 3B are similar to FIGS. 2A and 2B respectively, except for the orientation of the positioning device 118 and the power cable 102. As is evident from FIGS. 3A and 3B, the positioning device is rotated substantially 90° clockwise from the orientation illustrated in FIGS. 2A and 2B, e.g., with the opening away from the power cable receptacle 116, but could also be rotated substantially 90° in the opposite direction. The orientation of the positioning device 118 allows for the power cable 102 to be routed out of the left side 110.

In order to assemble the home appliance 100 as illustrated in FIGS. 3A and 3B, a user determines that the power cable 102 will be routed out the left side 110. The positioning device 118 is oriented in the illustrated orientation, e.g., with the opening away from the power cable receptacle 116, which allows the power cable 102 to pass through the positioning device substantially vertically, and fixed adjacent to the locating mark 120. The power cable 102 is inserted into the power cable receptacle 116, inserted into the positioning device 118, and routed through the back strap 112b. The steps can be performed in any order, or the order recited.

The positioning device 118 can be fixed to the home appliance 100 using any suitable fastening method. For example, the positioning device could be fastening in place using an adhesive, which may result in an orientation of the positioning device 118 that is not readily changed. This may be particularly well suited when the power cable 102 will routed only once and not changed later. The positioning device 118 could also be affixed by means that are more susceptible to future changes in orientation. For example, the positioning device 118 could be fastened by a threaded fastener and nut that allows any orientation and/or later re-orientation. The positioning device 118 could also be attached to and rotatable on a shaft where detents may be provided to urge the rotation of the positioning device 118 to stay in two or more predetermined positions. The positioning device 118 could be allowed to freely rotate, e.g., on a shaft or loose rivet, such that the routing of the power cable 102 controls the orientation of the positioning device 118.

As is evident from the forgoing description and the figures, the overall length of the power cable 102 is greater than a length of the power cable 102 that extends out of the home appliance 100, e.g., greater than a length of the power cable 102 that extends beyond the back straps 112a, 112b.

The present technology provides certain advantages. For example, the power cable 102 is able to extend no more than a maximum distance beyond either lateral side of the home appliance 100 while still meeting UL and/or NEC standards. This allows greater flexibility in the installation location of the home appliance 100 while maintaining a standard configuration of the power cable 102.

While the present technology has been described in connection with several practical examples, it is to be understood that the technology is not to be limited to the disclosed examples, but on the contrary, is intended to cover various modifications and equivalent arrangements included within the spirit and scope of the technology.

What is claimed is:

1. A method of assembling a power cable to a home appliance, the method comprising:
determining a side that the power cable will be routed out of the home appliance, the determined side being a right side or a left side;
determining an orientation of a positioning device corresponding to the determined side;
fastening the positioning device to fix the orientation, the positioning device being fastened adjacent to a locating mark on the home appliance that is disposed between the left side and the right side of the home appliance, the locating mark being the same regardless of the orientation;
electrically connecting the power cable to a power cable receptacle on the home appliance;
fastening the power cable to the positioning device; and
routing the power cable out of the determined side.

2. The method according to claim 1, wherein the orientation is a first orientation or a second orientation, the first orientation and the second orientation being rotated 90° apart from one another.

3. The method according to claim 1, wherein the locating mark is a leg adjuster for the home appliance.

4. The method according to claim 1, wherein the positioning device is located such that the power cable extends a same distance outside of a housing of the home appliance regardless of the determined side without altering the overall length of the power cable.

5. The method according to claim 1, wherein the home appliance includes a back strap at the determined side.

6. The method according to claim 5, wherein the power cable is routed through the back strap.

7. The method according to claim 1, wherein the home appliance is a dishwasher.

8. The method according to claim 1, wherein the positioning device is a clip with an opening, the opening being oriented up when the determined side is the right side and the opening being oriented towards the right side when the determined side is the left side.

9. The method according to claim 8, wherein the power cable receptacle is located on the left side.

10. The method according to claim 1, wherein the positioning device is a clip with an opening, the opening being oriented up when the determined side is opposite the power cable receptacle and the opening being oriented away from the power cable receptacle when the determined side is a side where the power cable receptacle is located.

11. The method according to claim 1, wherein the method is performed in the order recited.

12. A home appliance comprising:
a housing with a left side and a right side;
a power cable electrically connected to a power receptacle that is set off towards one side of the home appliance; and
a positioning device adapted to position and hold the power cable,
wherein the power cable extends from the housing no more than substantially a predetermined length when the power cable is routed out of the left side and when the cable is routed out of the right side.

13. The home appliance according to claim 12, wherein the positioning device is adapted to be oriented in a first orientation or and a second orientation, the first orientation and the second orientation being rotated 90° apart from one another.

14. The home appliance according to claim 12, wherein the home appliance includes no more than one power receptacle adapted to mate with the power cable.

15. The home appliance according to claim 14, wherein the power receptacle is located on a rear portion of the home appliance and facing towards the back of the home appliance, the power cable being routed out of the home appliance at approximately a same height as the power receptacle.

16. The home appliance according to claim 12, further comprising a locating mark to locate the positioning device.

17. The home appliance according to claim 16, wherein the locating mark is a leg adjuster.

18. The home appliance according to claim 12, further comprising a back strap at the left side or the right side, wherein the power cable is routed through the back strap.

19. The home appliance according to claim 12, wherein the home appliance is a dishwasher.

20. The home appliance according to claim 12, wherein the positioning device is a clip that is substantially D-shaped and that allows the power cable to pass into and out of the D-shape at an opening at a top of the D-shape.

21. The home appliance according to claim 12, wherein the power cable has a predetermined overall length that is longer than the length the power cable extends from the home appliance.

22. A home appliance comprising:
a power receptacle;
a power cable;
a positioning device adapted to be oriented in a first position and a second position depending which of two sides of the home appliance that the power cable is routed out of; and
a locating mark on the home appliance that is disposed between the two sides of the home appliance, the locating mark being the same regardless of the orientation;
wherein the power cable is electrically connected to the power receptacle, fastened to the home appliance by the positioning device, and routed out of one of the two sides.
